(19) United States
(12) Patent Application Publication
(10) Pub. No.: US 2012/0065310 A1
(43) Pub. Date: Mar. 15, 2012

(54) COMPOSITION, COATED FILM FORMED OF THE COMPOSITION, LAYERED PRODUCT CONTAINING THE COATED FILM, AND ELECTRONIC DEVICE INCORPORATING THE LAYERED PRODUCT

(76) Inventors: Hiroaki Adachi, Tokyo (JP); Enhai Sun, Tokyo (JP); Eiji Honda, Tokyo (JP); Yoro Sasaki, Tokyo (JP); Syuzou Waki, Yokohama-shi (JP); Toshiyuki Goshima, Yokohama-shi (JP); Yoshikazu Nishikawa, Yokohama-shi (JP)

(21) Appl. No.: 13/296,012

(22) Filed: Nov. 14, 2011

Related U.S. Application Data
(62) Division of application No. 12/398,954, filed on Mar. 5, 2009.

(30) Foreign Application Priority Data
Dec. 26, 2008 (JP) 2008-334314

(51) Int. Cl. C08K 5/07; C08L 79/08

(52) U.S. Cl. 524/357

(57) ABSTRACT

An object is to provide a composition that has good viscosity stability and flowability at the time of processing, good shape retention after the processing, and good drying property in a temperature range of not degrading the conductor layer at the time of drying and that enables a coated film excellent in strength of adhesion with metal•polyimide, flame resistance, heat resistance, flexibility, mechanical properties, and chemical resistance to obtained after being dried. To meet this object, a composition is prepared containing (A) polyimide and (B) mixed solvent of two kinds or more, and the solubility parameter of the mixed solvent of two kinds or more ranges from 9 to 14.

This application is a Divisional of copending application Ser. No. 12/398,954 filed on Mar. 5, 2009, which claims priority to Application No. 2008-334314 filed in Japan, on Dec. 26, 2008. The entire contents of all of the above applications are hereby incorporated by reference.

### TECHNICAL FIELD

The present invention relates to a composition that has a solvent and polyimide as essential components and that is excellent in chemical resistance, storage stability, heat resistance and electric characteristics useful as a material for a printed circuit board having an electronic circuit and electronic device incorporating the printed circuit board, coated film formed of the composition obtained by drying the composition, layered product containing the coated film, and electronic device incorporating the layered product.

### BACKGROUND ART

Insulating materials used on a wiring port ion of a flexible printed circuit board having an electronic circuit are principally formed of a composition having as main components acrylic resin and epoxy resin due to economic efficiency, heat resistance, chemical resistance and the like. However, the insulating materials formed of a composition having epoxy resin as a main component are poor in flexibility, and have problems of having insufficient characteristics in micro wiring, high-density packaging, compliance to halogen-free lead-free solder in environmental consideration, and further, respects such as heat resistance, electric characteristics and the like.

Meanwhile, to solve the problems, a method is proposed for using a composition formed of polyimide precursors as an insulating material (see Patent Documents 1 and 2). However, when polyimide precursors are used, functional groups contained in the polyimide precursors react with a conductor layer and degrade the reliability of electric circuitry, and imidization by ring closure reaction is indispensable to develop mechanical properties, flexibility, chemical resistance and the like. Imidization requires heat treatment at high temperatures, and causes deterioration of the conductor layer in the heat treatment at high temperatures. It is thereby necessary to perform heat treatment in a vacuum or in an atmosphere of inert gas such as nitrogen or the like, and an apparatus equipped for the heat treatment is required.

To solve these problems, a method is proposed for using a composition formed of a solvent and polyimide soluble in the solvent as an insulating material (see Patent Documents 3 and 4). In this method, heat treatment at high temperatures is not indispensable for imidization, function groups contained in the polyimide precursor disappear, deterioration of the conductor layer does thereby not occur, and electric characteristics, reliability of the printed circuit board and the like are more excellent than those in conventional products. However, N,N-dimethylacetamide, N-methyl-2-pyrrolidone, γ-butyrolactone and the like that are suitably used to polymerize the polyimide precursor have hygroscopic, solubility of polyimide decreases when water is absorbed, polyimide precipitates, or the appearance of the composition changes to white, the composition becomes heterogeneity, and various failures thereby occur in processing.

Therefore, required is a composition which can be used as a polymerization solvent, has polyimide with stability as a composition and formability, and which enables a coated film excellent in flexibility to be obtained. Particularly, it is necessary to provide a composition that first has the solvent soluble property advantageous in coating processing and that enables obtainment of a coated film with heat resistance, chemical resistance, flame resistance, electric characteristics and particularly improved solvent resistance after heat treatment.

To solve these problems, compositions of a solvent and polyimide soluble in the solvent are proposed (see Patent Document 5), but applicable structures of polyimide are limited, while the compositions have difficulty in long-duration processing stability at room temperature. Further, combinations of polyimide with structure in the wider range and solvent dissolving the polyimide are proposed (see Patent Document 6), but when the combinations are used as a composition for another insulating material, for example, polyimide, structures of targeted polyimide are limited. Furthermore, combinations of mixed solvent and polyimide soluble in the mixed solvent are proposed (see Patent Document 7), but lack effectiveness as a composition.

Polyimide is generally obtained by polymerizing the polyimide precursor using a single solvent in particular polar solvent with the solubility parameter exceeding 10. The solubility parameter described herein is also known as an SP value, used are numeric values described in p. VII/525˜526 in “Polymer Handbook/edited by J. Brandrup, E. H. Immergut. 3rd ed. A Wiley-Interscience Publication”, and when the designation is not described, used is a value calculated using a value of Small with the value of a methylene group being 272. Further, when the chemical structure is not described, a value of van Krevelen is used. Herein, the reason for polymerization using a single solvent with the solubility parameter exceeding 10 in particular a polar solvent is that the solvent has the solubility parameter similar to the solubility parameter of polyimide. More specifically, the polyimide precursor is polymerized using a solvent such as N,N-dimethylacetamide (the solubility parameter is 13.67), N-methyl-2-pyrrolidone (the solubility parameter is 14.03), γ-butyrolactone (the solubility parameter is 10.65) or the like.

Meanwhile, in the case of using another solvent, in particular, a solvent with the solubility parameter that does not reach 10 as a polymerization solvent of the polyimide precursor, the molecular weight often does not increase sufficiently up to the molecular weight causing development of mechanical properties, in particular, the degree of elongation exceeding 20%. Specific examples include triglyme (the solubility parameter is 8.32) and the like. Therefore, the polyimide precursor is polymerized using a solvent such as N,N-dimethylacetamide, N-methyl-2-pyrrolidone, γ-butyrolactone or the like, and the polyimide precursor with the sufficiently high molecular weight is further dehydrated to polymerize polyimide. However, since the polymerization solvents are apt to absorb moisture, when the composition formed of the solvent and polyimide obtained from polymerization of the polyimide is used for a long time under normal conditions, the polyimide solubility degrades due to moisture absorption, part of the polyimide participates, the composition changes to white and becomes heterogeneity, and therefore, the structure obtained by removing the solvent from the composition also becomes heterogeneity and unstable.

### PRIOR ART DOCUMENTS

### Patent Documents

[Patent Document 1] JP No. H11-207901

[Patent Document 2] JP No. H11-207902

[Patent Document 3] JP No. 2000-255013

[Patent Document 4] JP No. 2007-56201

[Patent Document 5] JP No. 2007-177017

[Patent Document 6] JP No. 2004-231946

[Patent Document 7] JP No. 2001-213961

### DISCLOSURE OF INVENTION

### Problems to be Solved by the Invention

The present invention was carried out in view of the above-mentioned respects, and it is an object to provide a composition that has good viscosity stability and flowability at the time of processing, good shape retention after the processing, and good drying property in a temperature range of not degrading the conductor layer at the time of drying and that enables a coated film excellent in heat resistance, flexibility, chemical resistance and electric characteristics to be obtained after being dried, coated film formed of the composition obtained by drying the composition, layered product containing the coated film, and electronic device incorporating the layered product.

### Means for Solving the Problem

As a result of study diligently made to solve the above-mentioned problems, the inventor of the invention found out that by using a mixed solvent of two kinds or more partly using a solvent with a solubility parameter apart from the solubility parameter of polyimide, the mixed solvent enables polyimide to have sufficiently high molecular weight as a polymerization solvent, while suppressing moisture absorption as a composition, the solution of polyimide does not change to white under conditions at room temperature, in other words, precipitation of polyimide is suppressed not to cause the composition to be heterogeneity, the viscosity and processing flowability of the composition is further stabilized under conditions at room temperature because the mixed solvent is hard to vaporize from the composition containing the mixed solvent of two kinds or more, good desolvation is exhibited at temperatures of 250° C. or less for inhibiting oxidation and deterioration of the conductor layer when the composition is used in applications including an electronic circuit, and that the composition formed of the mixed solvent of particular two kinds or more and polyimide is thereby applicable to the object, and reached the invention based on the findings.

In other words, a composition of the invention contains (A) polyimide and (B) mixed solvent of two kinds or more, and the solubility parameter of the mixed solvent of two kinds or more ranges from 9 to 14.

### Advantageous Effect of the Invention

The composition of the invention has good viscosity stability and flowability at the time of processing, good shape retention after the processing, and good drying property in a temperature range of not degrading the conductor layer at the time of drying, and enables a coated film excellent in heat resistance, flexibility, chemical resistance and electric characteristics to be obtained after being dried.

### BRIEF DESCRIPTION OF DRAWINGS

FIG. 1 is a cross-sectional photograph (10 μm×10 μm) of a coated film obtained in Example 2;

FIG. 2 is a cross-sectional photograph (10 μm×10 μm) of a coated film obtained in Comparative Example 2;

FIG. 3 is a printing result obtained in Example 1 (10th shot);

FIG. 4 is another printing result obtained in Example 1 (10th shot);

FIG. 5 is a printing result obtained in Example 1 (100th shot); and

FIG. 6 is another printing result obtained in Example 1 (100th shot).

### BEST MODE FOR CARRYING OUT THE INVENTION

The present invention will specifically be described below.

A composition of the invention is comprised of (A) polyimide, and (B) particular mixed solvent of two kinds or more.

### (A) Polyimide

Polyimide for use in the invention provides the composition with heat resistance, flexibility, electric characteristics and the like. The solubility parameter of polyimide of the invention preferably ranges from 9 to 14. When the solubility parameter is 9 or more, polyimide is dissolved more excellently in the mixed solvent of two kinds or more used in the invention, and stability of the composition is improved. When the solubility parameter is 14 or less, hygroscopicity of the mixed solvent decreases, change to white of a wet film due to moisture absorption is suppressed, and the uniform coated film with excellent properties is obtained.

To improve stability of the composition, it is preferable that an absolute value of a difference in solubility parameter between polyimide used in the invention and the mixed solvent of two kinds or more is 2 or less.

In terms of improving stability of the composition, the polyimide used in the invention preferably contains chemical structures with the solubility parameter ranging from 6 to 8 and the solubility parameter ranging from 10 to 14. The chemical structure with the solubility parameter ranging from 6 to 8 is specifically a chemical structure of polyimide (the solubility parameter is 7.77) derived from bis(3,4-dicarboxyphenyl)ether acid dianhydride and diamino siloxane compound BY16-853U (made by Dow Corning Toray) (amino group equivalent: 459) and the like. The chemical structure with the solubility parameter ranging from 10 to 14 is specifically a chemical structure of polyimide (the solubility parameter is 12.05) derived from bis(3,4-dicarboxyphenyl)ether acid dianhydride and 1,3-bis(3-aminophynoxy)benzene and the like.

The polyimide for use in the invention is polyimide soluble in a particular mixed solvent of two kinds or more for use in the invention. The polyimide soluble in a particular mixed solvent of two kinds or more for use in the invention indicates that the polyimide precursor undergoes cyclodehydration and that the imidized product is dissolved in the solvent, does not provide the conductor layer with deterioration by functional groups such as a carboxyl group and the like contained in the polyimide precursor because the polyimide precursor is not contained in the composition, enhances reliability of the printed circuit board, is hard to undergo hydrolysis, and therefore, provides the composition with good stability.

The polyimide for use in the invention is preferably organosilicon-group-containing polyimide. The organosilicon-group-containing polyimide is polyimide containing organosilicon groups in the molecule. By containing organosilicon groups in the molecule, the solubility in the solvent is improved, and flexibility and bending property is improved in a coated film after coating and drying.

The organosilicon-group-containing polyimide for use in the invention is obtained from acid dianhydride and diamine. The diamine is comprised of organosilicon-group-containing diamine and diamine without containing an organosilicon group.

As the organosilicon-group-containing diamine, diamines enabling imidization with acid dianhydride are capable of being used without particular limitations, and more specifically, include diamines having a structure shown by following formula (1) or following formulas (2) to (4).

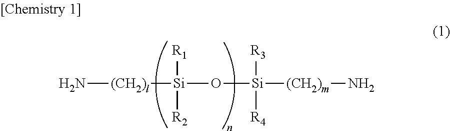

(where each of R1, R2, R3 and R4 in formula (1) independently represents an aliphatic group, alicyclic group, aromatic group, or aromatic group replaced with one to three aliphatic groups or oxygen-containing aliphatic group, each of l and m represents an integer ranging from 1 to 3, and n represents an integer ranging from 3 to 30.)

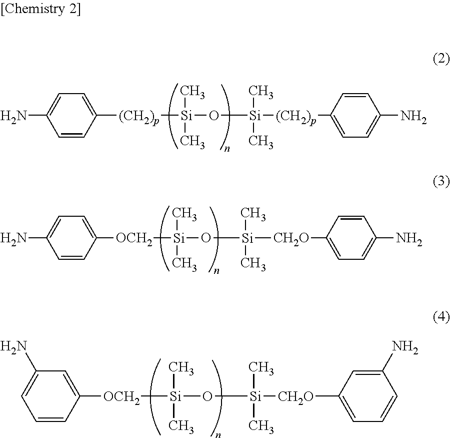

(where in formulas (2) to (4), p represents an integer ranging from 0 to 4, and n represents an integer ranging from 1 to 30, and preferably an integer ranging from 1 to 20.)

Among the organosilicon-containing diamines, only a single kind of diamine can be used, and a mixture of a combination of two kinds or more can also be used. As the above-mentioned organosilicon-containing diamine, it is possible to use commercially available products, for example, products sold by Shin-Etsu Chemical Co., Ltd., Dow Corning Toray, or Chisso Corporation without modification. Specific examples include KF-8010 (the amino group equivalent is about 450, R1, R2, R3 and R4 in formula (1) are methyl groups, l and m are 3) and X-22-161A (the amino group equivalent is about 840, R1, R2, R3 and R4 in formula (1) are methyl groups, l and m are 3) made by Shin-Etsu Chemical Co., Ltd.

As the diamine without containing an organoilicon group, diamines enabling imidization with acid dianhydride are capable of being used without particular limitations, and more specifically, aromatic diamines are generally used to improve heat resistance of polyimide, adhesion to the conductor layer and the degree of polymerization. Examples of such aromatic diamines include 9,9′-bis(4-aminophenyl)fluorene, m-phenylenediamine, p-phenylenediamine, 2,4-diaminotoluene, 4,4′-diamino-3,3′-dimethyl-1,1′-biphenyl, 4,4′-diamino-3,3′-dihydroxy-1,1′-biphenyl, 3,4′-diaminodiphyenylether, 4,4′-diaminodiphyenylether, 3,3′-diaminodiphyenylsulfone, 4,4′-diaminodiphyenylsulfone, 4,4′-diaminodiphyenylsulfide, 2,2-bis(4-aminophenyl)propane, 2,2-bis(4-aminophenyl)hexafluoropropane, 1,3-bis(3-aminophenoxy)benzene, 1,3-bis(4-aminophenoxy)benzene, 1,4-bis(4-aminophenoxy)benzene, 4,4′-bis(4-aminophenoxy)biphenyl, 2,2-bis[4-(4-aminophenoxy)phenyl]propane, 2,2-bis[4-(4-aminophenoxy)phenyl]hexafluoropropane, bis[4-(3-aminophenoxy)phenyl]sulfone, bis[4-(4-aminophenoxy)phenyl]sulfone, 2,6-diaminopyridine, 2,6-diamino-4-methylpyridine, a,a-bis(4-aminophenyl)-1,3-diisopropylbenzene, a,a-bis(4-aminophenyl)-1,4-diisopropylbenzene, 3,5-diamino benzoic acid, and 3,3′-dicarboxy-4,4′-diaminodiphenylmethane.

As acid dianhydride, acid dianhydrides enabling imidization with diamine are capable of being used without particular limitations, and more specifically, aromatic acid dianhydrides are generally used in terms of heat resistance of polyimide, and compatibility with organosilicon-group-containing diamine and diamine without containing an organosilicon group. Examples thereof include pyromellitic dianhydride, 3,3′,4,4′-biphenyl tetracarboxylic acid dianhydride, bis(3,4-dicarboxyphenyl)ether acid dianhydride, 3,3′,4,4′-benzophenone tetracarboxylic acid dianhydride, bicyclo[2,2,2]oct-7-en-2,3,5,6-tetracarboxylic acid dianhydride, 3,3′,4,4′-biphenyl sulfone tetracarboxylic acid dianhydride and the like. Among the acid dianhydrides, from the viewpoints of heat resistance of polyimide, adhesion of the conductor layer, compatibility with organosilicon-group-containing diamine, and polymerization rate, preferable examples are 3,3′,4,4′-biphenyl tetracarboxylic acid dianhydride, bis(3,4-dicarboxyphenyl)ether acid dianhydride, 3,3′,4,4′-benzophenone tetracarboxylic acid dianhydride, and 3,3′,4,4′-biphenyl sulf one tetracarboxylic acid dianhydride. Among exemplified acid dianhydrides, it is possible to use a single compound alone, or combine two compounds or more to use.

In manufacturing polyimide, corresponding polyamide acid is first manufactured. Herein, synthesis reaction of polyamide acid is not limited particularly, includes publicly known methods, and is usually carried out in a solvent. The solvent used in this reaction is not limited particularly, as long as the solvent is inert in the reaction and enables sufficiently high molecular weights of polyimide to develop mechanical properties, in particular, the degree of elongation of 20% or more. For example, N,N-dimethylformamide, N,N-dimethylacetamide, N-methyl-2-pyrrolidone, cresylic acid, dimethylsulfoxide, γ-butyrolactone or the like is used alone or in a mixed form with the solute density ranging from 5 percent by mass to 80 percent by mass. Used preferably are N,N-dimethylformamide, N-methyl-2-pyrrolidone, and γ-butyrolactone with the solubility parameter approximate to that of polyimide. γ-butyrolactone is particularly preferable. Further preferably, (B) mixed solvent of the invention described later is used as a polymerization solvent because it is not necessary to replace the solvent used in polymerization as a composition with another solvent.

The degree of polymerization of polyamide acid obtained herein preferably ranges from 2 to 600. In addition, the polyimide has the same degree of polymerization as that of original polyamide acid. The degree of polymerization can be calculated based on the weight average molecular weight measured by GPC. Adjustments of the degree of polymerization can be controlled by adjusting the mole ratio of monomer components as in normal polycondensation type polymers. For example, 0.8 mole to 1.2 mole of diamine component is used with respect to 1 mole of acid dianhydride component. Used preferably is 0.9 mole to 1.1 mole of diamine with respect to 1 mole of acid dianhydride component.

Obtained polyamide acid preferably has the solution viscosity thereof in the range of 2,000 mPa·s to 200,000 mPa·s. The viscosity is measured, for example, using a rotational viscometer (B-type viscometer) and E-type viscometer based on Japanese Pharmacopeia.

Imidization reaction is carried out by dehydrating the polyamide acid obtained by the above-mentioned method by the publicly known method. For example, although chemical imidization method is not limited particularly to the polyamide acid obtained in the above-mentioned reaction, dehydration is chemically performed by using alone or mixing two or more kinds of dehydrating agents such as acetic anhydride, trifluoro acetic anhydride, polyphosphoric acid, phosphorus pentaoxide, phosphorus pentachloride, thionyl chloride and the like to act. Reaction conditions of the chemical imidization method are not limited particularly, and publicly known conditions are applicable.

Preferable examples of polyimide soluble in a solvent of the composition of the invention, in particular organosilicon-group-containing polyimide will be described specifically.

It is possible to obtain organosilicon-group-containing polyimide for use in the invention also from two-stage reaction. First, in the presence of a basic catalyst, or mixed catalyst formed of lactones or an acid compound and base, an acid dianhydride component and a diamine component containing organosilicon groups in the molecular frame are subjected to polycondensation using the (B) mixed solvent to obtain organosilicon-group-containing polyimide oligomer, the oligomer is subjected to polycondensation with the acid dianhydride component and/or diamine without containing an organosilicon group in the molecular frame using the (B) mixed solvent described later to extend the chain, and the polyimide is obtained. This method prevents random copolymerization caused by exchange reaction occurring between organosilicon-group-containing polyimide precursors to obtain block copolymer, and therefore, enables the solubility of organosilicon-group-containing polyimide to be enhanced, and the storage stability of the composition of the invention, electric characteristics and mechanical properties to be improved, as compared with the method of mixing three components or more to obtain random copolymer.

In the first-stage reaction, diamine containing organosilicon groups in the molecular frame and acid dianhydride are used, and the first-stage reaction may further include diamine other than the organosilicon-group-containing diamine. As such diamine, aromatic diamines are generally used to improve heat resistance of polyimide, adhesion to the conductor layer and the degree of polymerization. Examples of such aromatic diamines include 9,9′-bis(4-aminophenyl)fluorene, m-phenylenediamine, p-phenylenediamine, 2,4-diaminotoluene, 4,4′-diamino-3,3′-dimethyl-1,1′-biphenyl, 4,4′-diamino-3,3′-dihydroxy-1,1′-biphenyl, 3,4′-diaminodiphyenylether, 4,4′-diaminodiphyenylether, 3,3′-diaminodiphyenylsulfone, 4,4′-diaminodiphyenylsulfone, 4,4′-diaminodiphyenylsulfide, 2,2-bis(4-aminophenyl)propane, 2,2-bis(4-aminophenyl)hexafluoropropane, 1,3-bis(3-aminophenoxy)benzene, 1,3-bis(4-aminophenoxy)benzene, 1,4-bis(4-aminophenoxy)benzene, 4,4′-bis(4-aminophenoxy)biphenyl, 2,2-bis[4-(4-aminophenoxy)phenyl]propane, 2,2-bis[4-(4-aminophenoxy)phenyl]hexafluoropropane, bis[4-(3-aminophenoxy)phenyl]sulfone, bis[4-(4-aminophenoxy)phenyl]sulfone, 2,6-diaminopyridine, 2,6-diamino-4-methylpyridine, a,a-bis(4-aminophenyl)-1,3-diisopropylbenzene, α,α-bis(4-aminophenyl)-1,4-diisopropylbenzene, 3,5-diamino benzoic acid, and 3,3′-dicarboxy-4,4′-diaminodiphenylmethane.

The ratio of the diamine containing organosilicon groups used in the first stage to all diamine components including diamine used in the second stage ranges from 15 percent by mass to 85 percent by mass, and preferably from 35 percent by mass to 80 percent by mass. When the diamine unit containing organosilicon groups is 15 percent by mass or more, the elasticity and flexibility is improved, and it is preferable in terms of reducing the amount of curling in the substrate, and improving adhesion. When the diamine unit containing organosilicon groups is 85 percent by mass or less, heat resistance is improved. Further, the molar ratio between all of diamine and all of acid dianhydride in the first stage preferably ranges from 0.5 to 2.0, and the molar ratio between all of diamine and all of acid dianhydride in the second stage ranges from 0.95 to 1.05, and preferably from 0.98 to 1.02.

Used as a catalyst for the reaction is a one-component base catalyst, or mixed catalyst formed of lactones or an acid compound and base. Examples of the one-component base catalyst include tertiary amines such as triethylamine and tributylamine, pyridine derivatives such as pyridine, 2-methylpyridine and 2,3-lutidine, 1,4-dimethylpiperazine, N-methylmorpholine and the like. Examples of the mixed catalyst include mixtures of lactones such as β-butyrolactone and γ-valerolactone or acid compound such as crotonic acid, oxalic acid and the like and base compound as described above. In the case of using the mixed catalyst of acid compound and base catalyst, the mixing ratio between acid and base is 1:1˜5 (molar equivalent) and preferably 1:1˜2. In the case of the mixed catalyst of lactones and base catalyst, the catalyst exhibits the catalyst function as a double salt of acid-base in the presence of water, thereby completing dehydration and imidization, and when water goes out of the reaction system, loses the catalyst function. The amount of usage of the one-component or mixed catalyst to all of acid dianhydride (including acid dianhydride when used in the second stage) is in the range of 1/100 to 1/5 mole and preferably in the range of 1/50 to 1/10 mole. Further, to remove water generated by dehydration and imidization, it is possible to use a solvent that is azeotropic with water and distilled. Examples of such a solvent include aromatic type compounds such as alkyl benzenes such as benzene, toluene and xylene, alkoxybezenes such as methoxybenzene, and the like.

As conditions of the first-stage reaction, the temperature ranges from 140° C. to 180° C., and the reaction time is not limited particularly, but generally ranges from 0.5 hour to 3 hours. The generated water is removed out of the system continuously by azeotropy.

When the amount of generated water has reached the theoretical amount and the water is not released out of the system, the resultant is cooled, and added is the acid dianhydride component and/or diamine component without containing an organosilicon group in the molecular frame to cause the second-stage reaction. As the acid dianhydride component and diamine component without containing an organosilicon group to be used, the examples as described previously can be used herein. The components used in the second stage may be the same as or different from the components used in the first stage. Specific conditions will be described in Examples, and a predetermined amount of each of acid dianhydride, diamine compound, and solvent for use in the second stage is added, and the mixture is reacted at 140° C. to 180° C. as in the first stage. The generated water is removed out of the system continuously by azeotropy. When the water is not generated any more, the water is distilled away completely. When the water is not distilled away completely at this point the water vaporizes in printing, and causes a change in viscosity, contamination in the environmental atmosphere and the like, being not preferable. The reaction time is not limited particularly, and generally ranges from 3 hours to 8 hours, and since the polymerization reaction can be monitored by viscosity measurement and/or GPC measurement, the reaction is usually continued up to a predetermined viscosity and/or molecular weight. The weight average molecular weight of organosilicon-group-containing polyimide preferably ranges from 30,000 to200,000, and more preferably from 30,000 to 120,000. Further, it is possible to add acid anhydride such as phthalic acid anhydride and aromatic amine such as aniline and the like as a terminator.

In addition, general manufacturing of polyimide of block copolymer soluble in solvent is described in the description of U.S. Pat. No. 5,502,143.

It is thus possible to obtain solvent soluble polyimide. The solid density at this point is preferably in the range of 10 percent by mass to 50 percent by mass, and more preferably in the range of 40 percent by mass to 50 percent by mass. When the solid density is 10 percent by mass or more, it is easy to make a coated film thick. When the solid density is 50 percent by mass or less, the formability of the composition is improved.

The obtained polyimide can be the composition of the invention without modification or by further adding a required solvent, additive and the like.

### (B) Mixed Solvent

As the mixed solvent of two kinds or more for use in the invention, two or more kinds of solvents are mixed to be used. It is indispensable that the solubility parameter of the mixed solvent is in the range of 9 to 14. The solubility parameter described above is also known an SP value, used were numeric values described in p. VII/525˜526 in “Polymer Handbook/edited by J. Brandrup, E. H. Immergut. 3rd ed. A Wiley-Interscience Publication”, and when the designation is not described, used was a value calculated using a value of Small with the value of a methylene group being 272. Further, for the chemical structure without description, a value of van Krevelen was used. The solubility parameter of the mixed solvent of two kinds or more can be obtained from the solubility parameter of each solvent and the weight average content of each solvent. When the solubility parameter of the solvent of two kinds or more is 9 or more, the solubility of the chemical structure for developing flexibility of polyimide is increased, and flexibility of the composition is improved. When the solubility parameter of the solvent of two kinds or more is 14 or less, the solubility of the chemical structure for developing heat resistance of polyimide is increased, and heat resistance of the composition is improved.

In the mixed solvent of two kinds or more for use in the invention, it is preferable that an absolute value of a difference in solubility parameter between the solvent with the highest solubility parameter and the solvent with the lowest solubility parameter contained in the mixed solvent is 1.2 or more, from the viewpoint of developing flexibility and heat resistance of the composition in good balance.

Specific examples of the mixed solvent of two kinds or more are mixed solvents formed of butyl benzoate of 80 parts by mass/γ-butyrolactone of 20 parts by mass (the solubility parameter is 9.64) and the like.

The mixed solvent of two kinds or more for use in the invention preferably contains an aromatic type solvent with the solubility parameter ranging from 9 to 10 and a polar solvent with the solubility parameter ranging from 8.5 to 15. Further, it is preferable that an absolute value of a difference between the solubility parameter of the aromatic type solvent and the solubility parameter of the polar solvent ranges from 1 to 5. The aromatic type solvent excellently dissolves the chemical structure rich in flexibility of polyimide, and the polar solvent excellently dissolves the chemical structure rich in heat resistance of the polyimide.

Specific example of the aromatic type solvent are solvents of benzoates such as n-propyl benzoate, isopropyl benzoate, n-butyl benzoate, isobutyl benzoate, tert-butyl benzoate, n-amyl benzoate, sec-amyl benzoate, 3-pentyl benzoate, 2-methyl-1-butyl benzoate, isoamyl benzoate, tert-amyl benzoate, 3-methyl-2-butyl benzoate, neopentyl benzoate and the like. Among the solvents, benzoate solvents having hydrocarbons with the carbon number between 3 and5 are preferable in terms of drying property after processing the composition, and particularly, butyl benzoate (the solubility parameter is 9.38) is preferable from the viewpoint of balance between hygroscopicity and drying property of the polar solvent.

As the polar solvent, acetamide type, pyrrolidone type, and lactone type are preferably in terms of polymerization property, and specific examples include N,N-dimethylacetamide, N-methyl-2-pyrrolidone, γ-butyrolactone and the like. Among the solvents, lactone type solvents are preferable in terms of economical efficiency, availability, and environmental properties, and particularly, γ-butyrolactone (the solubility parameter is 10.65) is preferable from the viewpoints of storage stability of the composition and drying property after processing.

Among the solvents, the percent content of the aromatic type solvent of the mixed solvent for use in the invention preferably ranges from 60 percent by mass to 95 percent by mass. When the percent content of the aromatic type solvent of the mixed solvent for use in the invention is 60 percent by mass or more, the solubility of the composition is improved. When the percent content of the aromatic type solvent of the mixed solvent for use in the invention is 95 percent by mass or less, the polymerization property is improved. The mixed solvent of two kinds or more for use in the invention is preferably between 1 part by mass and 1000 parts by mass with respect to 100 parts by mass of polyimide. The mixed solvent of 1 part by mass or more causes the workability to be improved, while the mixed solvent of 100 parts by mass or less causes the film to be easily made thick.

The mixed solvent for use in the invention preferably has a small difference between the solubility parameter of polyimide and the solubility parameter of the mixed solvent. By using a mixed solvent with a small difference in solubility parameter from polyimide, the solubility of polyimide in the solvent is enhanced. An absolute value of a difference between the solubility parameter of the mixed solvent for use in the invention and the solubility parameter of polyimide is preferably 2 or less, more preferably 1 or less, and further preferably 0.5 or less.

### (C) Particles of Metal Hydroxide

Particles of metal hydroxide may be used in the invention. A layered product having an electronic circuit patter is generally required to have flame resistance, and does not have problems with flame resistance, and particles of metal hydroxide are not indispensable in the invention. However, an improvement in flame resistance of a coated film formed of the composition according to the invention by adding particles of metal hydroxide further improves reliability of flame resistance of a layered product containing the coated film of the invention, and is preferable. In addition, a heterogeneous component exceeding 10 μm one-tenth the wiring width of 100 μm of the conventional electronic pattern has been recognized as a foreign matter for impairing reliability, but in recent years, since fine wiring is required for an electronic circuit, a heterogeneous component exceeding 5 μm one-tenth the wiring width of 50 μm has been recognized as a foreign matter for impairing reliability. Therefore, although uniform dispersion of finer particles is required, fine particles increase their surface area, coagulate by interaction between particles, and thereby tend to be bigger particles, dispersion is correlated with various factors such as type of solvent, composition of polymer, molecular weight, surface treatment of particle and the like, and therefore, it is not easy to uniformly disperse fine particles. It was found out that the particles of metal hydroxide capable of being used in the invention are excellently dispersed in polyimide and mixed solvent of two kinds or more according to the invention without using a dispersing agent easy to degrade the properties by defining the surface treatment, particle size and specific surface area, and that the particles of metal hydroxide are excellently dispersed in the coated film formed of the composition of the invention.

Further, in the case of using the particles of metal hydroxide, it is possible to provide the composition with flame resistance and thixotropy without using a halogen-containing material.

It is preferable that the particles of metal hydroxide for use in the invention are subjected to surface treatment by silicon dioxide, and have an average particle size ranging from 0.1 μm to 5 μm, and the specific surface area ranging from 5 m²/g to 50 m²/g.

The surface treatment with silicon dioxide provides the particles of metal hydroxide with acid resistance and an improvement in dispersion in polyimide, and contributes provision of thixotropy, and evenness of flame resistance.

The particles with the average particle size of 0.1 μm or more improve the handling property, are hard to coagulate, and can be dispersed in the composition easily. When the particles with the average particle size of 5 μm or less are used in a printed circuit board having fine electric wiring of 50 μmore or less, the possibility decreases that metal hydroxide is located in part of the insulating layer under the wiring, the probability decreases that peeling occurs due to reductions in adhesion between the wiring and insulating layer, and the reliability is improved.

The particles with the specific surface area of 5 m²/g or more improve the dispersing property in the composition, and the particles with the specific surface area of 50 m²/g or less do not contain fine particles, are thereby easy to handle and hard to coagulate, and improve the dispersing property.

Among the particles of metal hydroxide, it is preferable that the content of heavy metal is 1 percent by mass or less. When the total content of heavy metal is 1 percent by mass or less, the possibility decreases that heavy metal pollution or the like is caused by spilling heavy metal by acid or the like, and the environmental load is reduced. Further, the particles using alkali metal and/or alkaline earth metal are preferable in terms of the environmental properties, and the particles using magnesium hydroxide are the most preferable from the viewpoints of economic efficiency and availability.

In the particles of metal hydroxide for use in the invention, the content of silicon derived from silicon dioxide preferably ranges from 1 percent by mass to 30 percent by mass. The content of silicon derived from silicon dioxide can be measured using an X-ray fluorescence analysis apparatus. When the content of silicon derived from silicon dioxide is 1 percent by mass or more, improved is acid resistance, and dispersion in organosilicon-group-containing polyimide. When the content of silicon derived from silicon dioxide is 30 percent by mass or less, it is possible to provide flame resistance using the lower number of particles of metal hydroxide.

As the surface treatment method by silicon dioxide for particles of metal hydroxide for use in the invention, for example, there are a method for adding organo silicate such as sodium silicate and the like to slurry of the particles of metal hydroxide, then neutralizing with acid such as sulfuric acid or the like, and depositing silicon dioxide on the surfaces of the particles of metal hydroxide, and the like.

The additive amount of the particles of metal hydroxide for use in the invention ranges from 5 to 50 parts by mass with respect to 100 parts by mass of polyimide. In the amount of 5 parts by weight or more, it is easy to provide flame resistance and thixotropy. In the amount of 50 parts by weight or less, the particles are dispersed uniformly, and the flexibility of an obtained coated film is improved. In this case, the amount of the mixed solvent is not limited particularly, but preferably ranges from 1 part by mass to 1000 parts by mass.

### (D) Acetylacetone Metal Complex

The composition of the invention has the mixed solvent of two kinds or more and polyimide as described above as its components, and provides a coated film excellent in storage stability of the composition, flexibility, heat resistance, chemical resistance and the like by being used without modification, and by further adding an additive and the like, it is possible to provide the composition with functions.

As an additive, acetylacetone metal complexes are ordinary used to enhance adhesion to the conductor layer, and in the composition of the invention, it was found out that the acetylacetone metal complex produces the effect of remarkably improving solvent resistance, in particular resistance to methyl ethyl ketone. In other words, by adding the acetylacetone metal complex, in spite of containing polyimide soluble insolvent, the composition of the invention improves solvent resistance, in particular resistance to methyl ethyl ketone after being processed and dried. Among the acetylacetone metal complexes are acetylacetone copper, acetylacetone manganese, acetylacetone nickel, acetylacetone aluminium and the like, and are preferably complexes of light metal that do not cause heavy metal pollution, and particularly, in terms of availability, used preferably is acetylacetone aluminium that is aluminium complex. Further, the additive amount of the acetylacetone metal complex preferably ranges from 0.1 part by mass to 10 parts by mass with respect to 100 parts by mass of organosilicon-group-containing polyimide. The additive amount of 0.1 part by mass or more causes the effect of improving solvent resistance, while the additive amount of 10 parts by mass or less does not impair heat resistance of the coated film after being cured.

Further, there is the case that the acetylacetone metal complex impairs storage stability of a composition by interaction with an active group of polyimide derived from the solvent used in polymerizing polyimide, but with respect to the composition using polyimide polymerized using the mixed solvent of two kinds or more for use in the composition of the invention, even when the acetylacetone metal complex is added, excellent storage stability is shown to such an extent that any problem does not occur practically.

### (E) Other Components

The composition of the invention is low in sag and bleeding in printing and al so low in stickiness to the screen, and further, to provide more excellent thixotropy, it is possible to add publicly known filler and/or thixotropy adding agent to use. Used as the filler is insulating inorganic filler, resin-coated inorganic filler or resin filler. Among the insulating inorganic fillers are, for example, Aerosil, silica (average particle in the range of 0.001 μm to 0.2 μm), aluminium oxide, titanium dioxide, and phosphorus compounds (red phosphorus, condensed phosphate, and phosphazene compounds), and among the resin coated fillers are PMMA/polyethylene type, silica/polyethylene type, and the like. Examples of the resin filler include epoxy resin, melamine polyphosphate, melem, melamine cyanurate, maleimide resin, polyurethane resin, polyimide, polyamide, triazine compounds and the like, for example, in fine-particle form with the average particle size ranging from 0.05 μm to 100 μm. The filler is preferably fine particles with the average particle size ranging from 0.1 μm to 5 μm. The amount of filler preferably ranges from 5 to 20 parts by mass with respect to 100 parts by mass of polyimide. Examples of the thixotropy adding agent are silicic anhydride having silanol groups on its surface, for example, in fine-particle form (average particle size ranging from 1 μm to 50 μm). The amount of thixotropy adding agent preferably ranges from 5 parts by mass to 30 parts by mass with respect to 100 parts by mass of polyimide.

Further, it is possible to add a publicly known additive such as an anti-foaming agent, leveling agent and the like. As a leveling agent, for example, it is preferable to contain a surfactant component ranging from about 100 ppm to about 2 percent by mass, and it is thereby possible to suppress foaming, while improving evenness of coated films. Preferable are nonionic without containing an ionic impurity. Examples of suitable surfactants are “FC-430” of 3M company, “BYK-051” of Byk-Chemi, and Y-5187, A-1310, SS-2801-2805 of Nippon Unicar Company Limited. Examples of the anti-foaming agent include “BYK-A501” of Byk-Chemi and “DC-1400” of Dow Corning Corporation. Examples of the silicon type anti-foaming agent are SAG-30, FZ-328, FZ-2191, FZ-5609 of Nippon Unicar Company Limited., KS-603 of Shin-Etsu Chemical Co., Ltd., and the like. The additive amount is preferably in the range of 1 part by mass to 20 parts by mass with respect to 100 parts by mass of polyimide, and more preferably in the range of 2 parts by mass to 5 parts by mass.

Described next is a method of manufacturing the composition of the invention.

### (F) Composition

It is possible to prepare the composition of the invention using the above-mentioned components with an already-existing kneader such as a three roll mill, ball mill, homomixer, planetary mixer and the like.

In the composition of the invention, it is preferable that the rate of volatilization of the composition is 2.0 percent by mass/hour or less. The rate of volatilization is a value obtained by uniformly spreading 1 g of the composition with the polyimide solid content of 30 parts by mass in a glass dish with the inner diameter of 48 mm, and measuring a reduction in the composition per hour under conditions at 23° C. and at the humidity of 50%. When the rate of volatilization of the composition is 2.0 percent by mass/hour or less, stability of the viscosity of the composition or the like is improved, being suitable for long-duration continuous printing and the like.

In the composition of the invention, it is preferable that a wet film does not change to white when the coated and leveled wet film with the thickness of 25 μm of the composition of the invention is let stand for an hour under conditions at 23° C. and at the humidity of 50%. By the fact that the wet film does not change to white, the coated film is made uniform after being dried, improving reliability.

### (G) Ink

The ink of the invention is obtained by adding a coloring agent to the composition of the invention for the purpose of checking misregistration, waste, bleeding, penetration and the like after forming a pattern in the printing method. As the coloring agent, it is possible to use dye and pigment. Particularly, it is preferable to add phthalocyanine blue that is a halogen-free organic pigment high in reliability of insulation properties. The additive amount is preferably in the range of 1 part by mass to 20 parts by mass with respect to 100 parts by mass of the polyimide solid content, and more preferably in the range of 2 parts by mass to 5 parts by mass.

In the ink of the invention, since imidization is completed, the storage stability is excellent. The ink can be printed on a printed circuit board and the like with flexibility using screen printing, ink jet printing or precise dispensing method as a processing method for forming a coated film. Particularly, since the storage stability is excellent under conditions at room temperature, the ink can be used suitably for screen printing.

The ink of the invention enables the solid content to increase to 10 percent by mass to 50 percent by mass, and thereby enables formation of a thick film. Further, the ink does not develop precipitation due to moisture absorption, thereby hardly causes clogging in screen printing, has good storage stability, and is excellent in continuous printing property. Since the polyimide according to the invention is already imidized in the reaction process, it is possible to form a coated film formed of the polyimide only by drying and removing the solvent.

### (H) Coated Film

The coated film of the invention is suitably obtained by coating, leveling, and drying the composition of the invention.

As a condition for drying, depending on the coating film thickness, the film is dried at 80° C. to 250° C. using an oven or hot plate, and the temperature may be constant over the processing time, or gradually increased to dry. As the condition for drying, temperatures of 250° C. or less are preferable to protect the conductor layer, and improve curling in the board. Further, since polyimide is easy to absorb moisture, it is preferable to dry the film at 80° C. to 150° C. for 10 minutes to 120 minutes for the purpose of removing moisture, and then perform heat treatment at 150° C. to 250° C. for 10 minutes to 40 minutes, and evenness of the coated film is improved. Further, the maximum temperature in drying is in the range of 150 ° C. to 220 ° C., and it is preferable to apply heat at temperatures in an atmosphere for not degrading the conductor layer such as air environment, nitrogen environment, vacuum environment or the like for 5 minutes to 200 minutes.

In the coated film of the invention, it is preferable to control the residual solvent amount to within the range of 3 ppm to 100 ppm by drying after the processing. When the residual solvent amount is 3 ppm or more, significant curling difficult to allow does not occur in a flexible printed circuit board with the coated film formed thereon. The residual solvent amount of 100 ppm or less does not causes failure such as blowing, blister and the like in heat treatment at high temperatures such as solder reflow processing and the like.

The film thickness of the coated film of the invention preferably ranges from 1 μm to 50 μm. The film is easy to handle when the thickness is 1 μm or more, while being easy to bend and incorporate when the thickness is 50 μm or less.

### (I) Layered Product

The layered product of the invention is formed of the coated film of the invention and other components. Among the other components include an insulating material, conductor layer and an electric circuit formed of the insulating material and conductor layer.

Examples of the insulating material are glass fiber containing epoxy resin cured material, polyester film, and polyimide film. From the viewpoint of suitably developing flexibility of the coated film of the invention, flexible insulating materials are preferable, and particularly, from the viewpoint of suitably developing heat resistance of the coated film of the invention, insulating materials formed of polyimide are preferable.

The film thickness of the flexible insulating material is not limited particularly, but from the viewpoint of handing the layered product, is preferably in the range of 3 μm to 150 μm, more preferably in the range of 5 μm to 50 μm, and further preferably in the range of 7.5 μm to 40 μm.

Among the conductor layers include conductor layers comprised of metal and nonmetal, and metal is preferable in terms of economic efficiency and availability. The conductor layers comprised of metal are formed by sputtering, plating or metal foil. Use of metal foil is preferable from the viewpoint of economic efficiency. Further, as the metal foil, it is preferable to use electrolytic metal foil in terms of economic efficiency or rolled metal foil in terms of flexibility.

Among metals for use in the conductor layer are aluminium, stainless, copper and the like, and copper is preferable from the viewpoints of electrical conductivity and economic efficiency.

In the layered product of the invention, it is preferable to form and use a coated film of the invention on an electric circuit pattern formed by patterning the conductor layer on the insulating material by printing method or the like, from the viewpoint of developing protective properties of the electric circuit taking advantage of heat resistance, solvent resistance and electric characteristics of the coated film of the invention.

In the layered product of the invention, it is preferable to contain an independent area less than 2000 μm without the coated film being coated, in coating the insulating material containing the electric circuit with the composition or ink of the invention by the method such as screen printing or the like to form the coated film, from the viewpoint of developing shape retention after applying the composition or ink of the invention. The above-mentioned independent area less than 2000 μm is in the form of a circle, or polygon such as a rectangle or the like, and can be installed with an electric connection area of electronic parts such as LSI, resistor, capacitor and the like.

In the layered product of the invention, it is preferable to contain an independent area of 2000 μm or more with the coated film being coated thereon, in coating the insulating material containing the electric circuit with the composition or ink of the invention by the method such as screen printing or the like to form the coated film, from the viewpoint of developing shape retention after applying the composition or ink of the invention. The above-mentioned independent area of 2000 μm or more covered with the coated film is effective in protecting independent vias and pads of the insulating material containing the electric circuit, and is preferable in economic efficiency and environmental properties because it is possible to protect by the required minimum composition or ink.

In the layered product of the invention, it is preferable to apply electrolytic nickel-gold plating to the conductor layer without the film being coated, in terms of preventing deterioration of the conductor layer. Further, it is preferable to cause the electrolytic nickel-gold plating to crawl in less than 100 μm on the coated conductor layer side in the interface between the conductor layer with the coated film applied thereon and the conductor layer without the coated film, from the viewpoint of protecting the conductor layer.

The layered product of the invention is hard to cause deterioration in particular by heat of electronic parts with high caloric values, due to heat resistance of the coated film of the invention.

### (J) Electronic Device

The electronic device of the invention is an electronic device with the layered product of the invention bent and incorporated thereinto. The layered product of the invention is rich in the bending property, and provides good workability from low repulsion, and the coated film of the invention is rich in flexibility, and develops excellent reliability in bent state.

Described next are Examples and Comparative Examples carried out to clarify the effects of the invention.

Each property was measured by following methods.

1 The Content of Silicon Derived from Silicon Dioxide of Particles of Metal Hydroxide and the Content of Each Heavy Metal

X-ray fluorescence analysis apparatus 3270 type made by Rigaku Corporation was used for measurement on the following conditions. X-ray target: Rhodium, Voltage of X-ray tube: 50 kV, Current of X-ray tube: 50 mA, Detector: Scintillation counter, Gas-flow type proportional counter, Measurement atmosphere: Vacuum (about 1.3 Pa), Measurement element range: From F to U. Measurement samples were subjected to press molding in the shape of a disk with the diameter of 30 mm and the thickness of 5 mm.

### 2 Average Particle Size of Particles of Metal Hydroxide

Photographs of particles of metal hydroxide were taken using a scanning electron microscope, and particle sizes of any fifty typical particles were measured, and averaged to determine an average particle size.

### 3 Specific Surface Area of Particles of Metal Hydroxide

Measurement was performed by BET method for causing liquid nitrogen to be absorbed.

### 4 Rate of Volatilization of the Composition

In a glass dish with the inner diameter of 48 mm was spread 1 g of the composition with the polyimide solid content of 30 parts by mass, changes in weight were measured for 6 hours under conditions at 23° C., at the humidity of 50%, and at the flow rate between 0.2 m/s and 0.3 m/s, and the gradient was obtained by linear regression from the changes in weight in the measurement time between 100 minutes and 300 minutes, and converted into a value of a reduction of the composition per hour.

### 5 Repulsion Force

The layered product of width 15 mm and length 20 mm was used under conditions at 23° C. and at the humidity of 50%, an end portion of the layered product was fixed to an electronic balance, the other end port ion was then held, the central port ion of the layered product was bent with the bending radius of 0.5 mm and kept for a minute, and the weight was then measured to be the repulsion force (g/cm).

### EXAMPLE 1

### (Synthesis of Organosilicon-Group-Containing Polyimide Solution)

A bulb condenser provided with a moisture isolation trap was attached to a 2 L-separable three-neck flask provided with an anchor-type stirrer made of stainless steel. In the flask were placed 111.68 g (360 mM) of bis -(3,4-dicarboxyphenyl)ether acid dianhydride (made by MANAC Incorporated) (hereinafter abbreviated as ODPA), 165.24 g (180 mM) of diamino siloxane compound BY16-853U (made by Dow Corning Toray) (amino group equivalent: 459, hereinafter abbreviated as BY16), 4.33 g (43 mM) of γ-valerolactone, 6.83g (86 mM) of pyridine, 235.2 g of n-butyl benzoate, and 100.8 g of γ-butyrolactone. The mixture was stirred at room temperature at the stirring rate of 180 rpm in an atmosphere of nitrogen for 30 minutes, and further stirred at 180° C. for an hour. The water was removed during the reaction.

Then, the resultant was cooled, and as the second stage, added were 22.34 g (72 mM) of ODPA, 63.15 g (216 mM) of 1,3-bis(3-aminophenoxy)benzene (made by Mitsui Chemicals, Inc.) (hereinafter abbreviated as APB), 10.52 g (36 mM) of 1,3-bis(4-aminophenoxy)benzene (made by Wakayama Seika Kogyosha) (hereinafter abbreviated as TPE-R), 140 g of n-butyl benzoate, and 60 g of γ-butyrolactone. The mixture was reacted at 180° C. for 5 hours while stirring at 180 rpm. By removing reflux materials such as water out of the system during the reaction, obtained was an organosilicon-group-containing polyimide solution with the density of 41 percent by mass.

The molecular weight of thus obtained organosilicon-group-containing polyimide was measured with gel permeation chromatography (made by Tosoh Corporation). In terms of styrene molecular weight, the number average molecular weight (Mn) was 34,000, weight average molecular weight (Mw) was 60,000, and Z-average molecular weight (Mz) was 63,000. Further, the solubility parameter of the organosilicon-group-containing polyimide was 9.37.

### (Preparation of the Composition)

To 900 g of synthesized organosilicon-group-containing polyimide solution were added 325 g of n-butyl benzoate, 55.5 g (6 parts by mass with respect to 100 parts by mass of organosilicon-group-containing polyimide) of magnesium hydroxide, subjected to surface treatment by silica, with the average particle size of 0.8 μm and the specific surface area of 9.0 m²/g (from the result of composition analysis by X-ray fluorescence analysis, Mg 84.4 percent by mass, Si 14.9 percent by mass, Fe 0.04 percent by mass, Zn 0.02 percent by mass), 11.1 g of anti-foaming agent (made by Shin-Etsu Chemical Co., Ltd. KD-603), 3.7 g (0.4 part by mass with respect to 100 parts by mass of organosilicon-group-containing polyimide) of aluminum acetylacetonate, and 7.38 g of phthalocyanine blue powder that is an organic pigment, the mixture was adequately mixed with NR-120A Ceramic three-roll mill (made by Noritake Co., Limited), and a composition of the invention was obtained.

The solubility parameter of the mixed solvent of two kinds or more contained in the composition was 9.61. The rate of volatilization of the composition was 1.2 percent by mass/hour.

### (Evaluations of Printing•Continuous Printing)

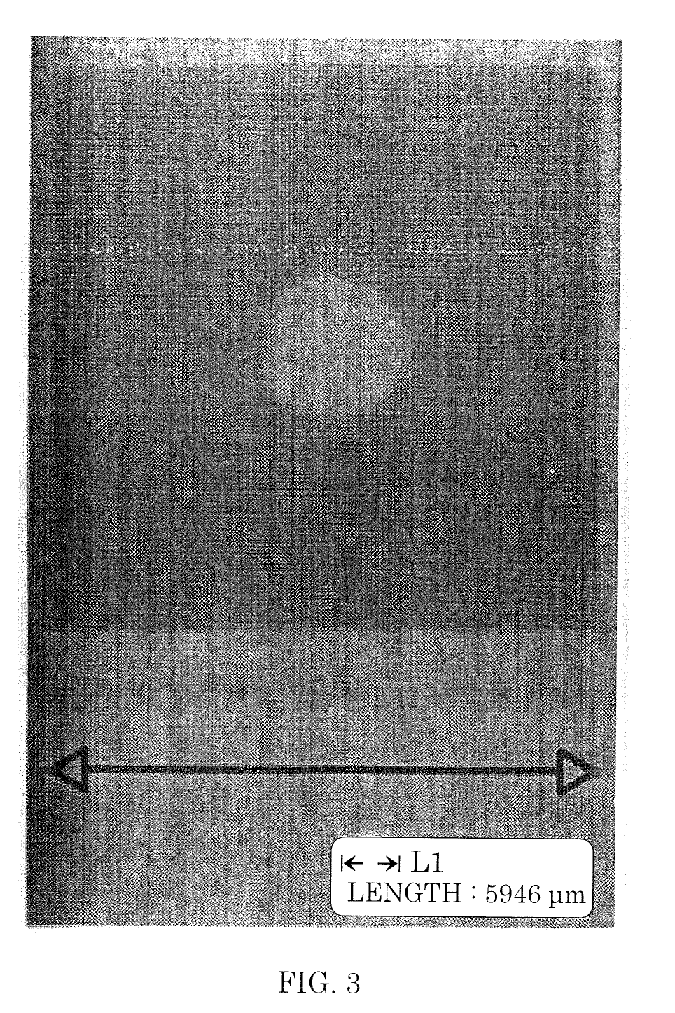

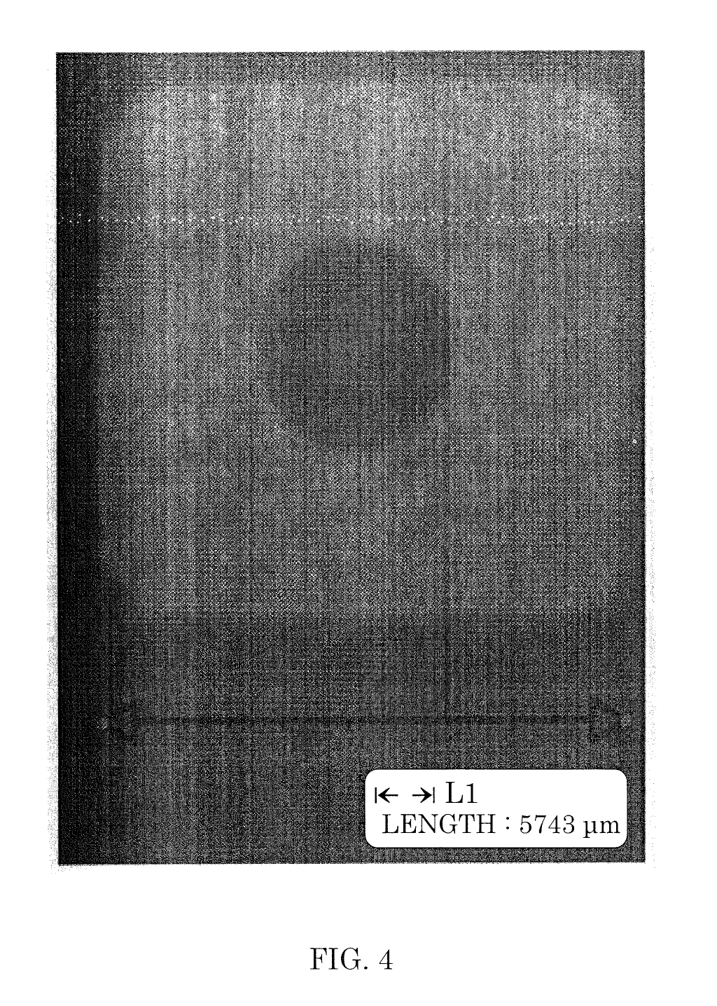

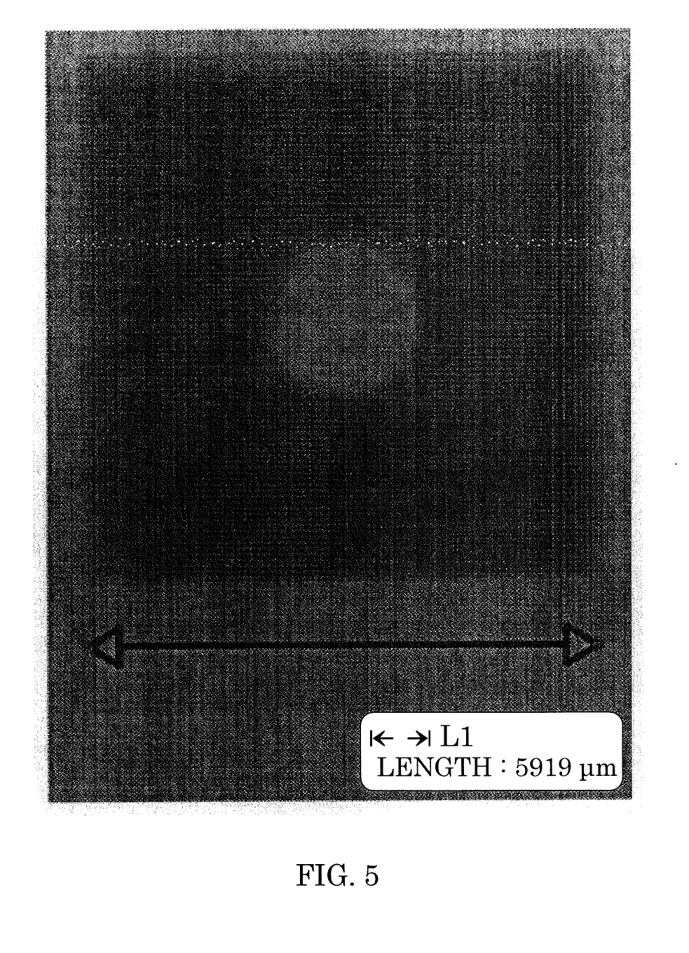

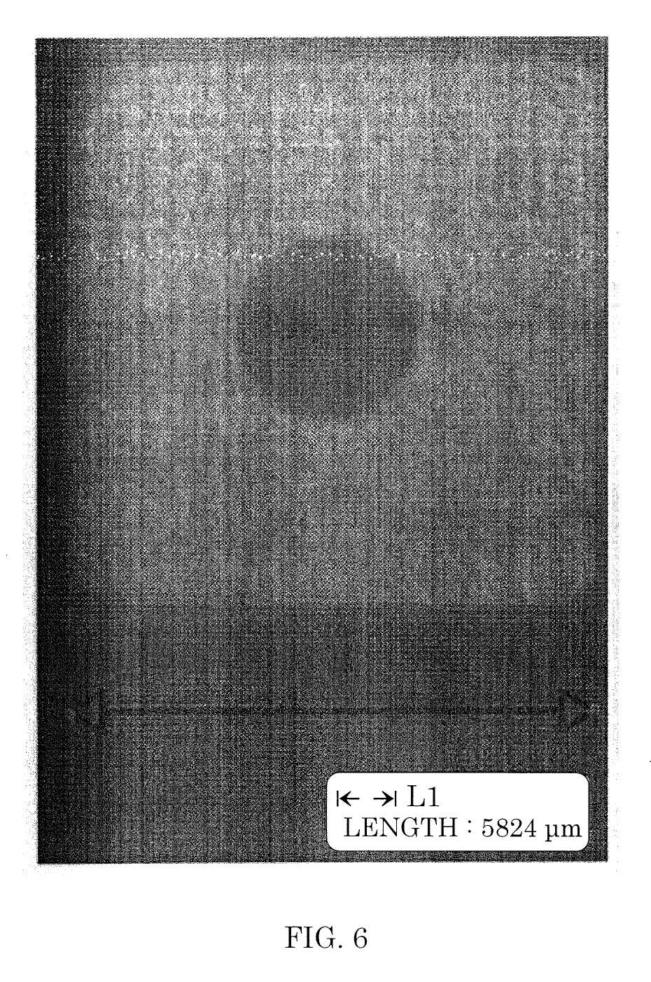

Printing was performed using a test printing screen (350-mesh stainless, emulsion thickness of 20 μm, frame size 180 mm×200 mm) and LS-25GX screen printer (Newlong Company). Conditions were set on the squeegee speed at 30 mm/s to 80 mm/s, gap (clearance) at 1.5 mm to 3.0 mm, squeegee angel at 70° C., and squeegee indentation amount at 0.3 mm, and printing was carried out. Characteristics were evaluated on evaluation items. For the polyimide protective film pattern shape, printing properties on the circuit board and in drawn opening pattern were investigated on a flexible circuit board. More specifically, the ink was printed over the surface on a circuit board with the pattern of copper traces with line/space: 30 μm/30 μm, 50 μm/50 μm, 100 μm/100 μm, 200 μm/200 μm, leveling was performed at room temperature for 5 to 10 minutes, the organic solvent components were dried by heating in a hot air oven at 120° C. for 60 minutes and at 200° C. for 30 minutes, and then, whether the ink was embedded in between spaces was investigated. Further, the printing property in drawn opening pattern was investigated preparing the circular pattern form (diameter of 2000 μm) and the rectangle pattern form (length of one side of 6000 μm). In addition, 100 shots of printing were performed continuously, the patterns were sampled at the 10th shot (see FIGS. 3 and 4) from the beginning of printing, and subsequently, every 10th shot up to 100 shots (see FIGS. 5 and 6), leveling and drying was carried out on the same conditions as described above, and the same pattern shape as described above was observed by viewing and a light microscope. Evaluations were made on embedding defect on the circuit wiring, “bleeding or sag defect (defect in bridge state such that the paste was spread in the pattern width direction and connected to an adjacent trace)” of patterning, “void or lack”, and “rolling property (defect in rotation state such that the paste rotates and flows in almost cylindrical shape at the front on the traveling direction side of the squeegee on the screen when the squeegee shifts)”. Excellent results were obtained on all the items. Further, bending evaluations (IR, outward bending) were made on the above-mentioned samples, any change in resistance in the copper trace area was not shown on all the samples, and any crack was not recognized in the bending portion either.

Further, the ink was printed on part of a circuit board with line/space: 30 μm/30 μm, 50 μm/50 μm, 100 μm/100 μm, 200 μm/200 μm, electrolytic nickel-gold plating was applied to the part without printing with the nickel thickness of about 5 μm and gold thickness of about 0.5 μm, and it was confirmed that crawling of plating in the part with the ink printed therein was less than 100 μm by X-ray florescence analysis. Further, as a result of observing the cross section, crawling of plating in the part with the ink printed therein was less than 100 μm, and it was confirmed that the insulation state between traces was excellent by a resistor. Moreover, the ink was printed in a comb-shaped area of a comb-shaped circuit board with line/space: 30 μm/30 μm, 50 μm/50 μm, 75 μm/75 μm, 100 μm/100 μm, and reliability tests were performed such that the resistance was measured while letting the boards stand for 1000 hours under conditions of DC 50V, 85° C. and humidity 85%. The resistance exceeding 10⁹Ω was maintained in all the boards during the test, and excellent results were obtained.

As a result of performing continuous printing, any abnormality was not found in the printing results after lapse of two hours. Further, after preparing the composition and storing at room temperature for three months, printing was performed on the same conditions as described above, the printing results were equal to the results as described above, and any abnormality was not found.

### (Evaluations of the Coated Film After Coating and Drying)

Used as printing targets for the above-mentioned printing were Kapton (registered trademark) 100EN made by Du Pont-Toray Co., Ltd. and copper foil F2-WS (18 μm) made by Furukawa Circuit Foil Co., Ltd. The printing was performed on both sides of 100EN, while being performed on one side of F2-WS, leveling and drying was performed on the same conditions as described above, and the targets were used in the following tests as samples.

A result of flammability of samples printed in 100EN was UL-94TVM-0, and indicated good flame resistance.

Curling (total of four corners measured by cutting the sample into 5 cm×5 cm) of samples printed in 100EN was 40 mm or less, and the good result with small curling and curl was obtained. The heat resistance of samples printed in F2-WS was tested by floating samples cut into 3 cm×3 cm in a bath of molten solder at 260° C. for 60 seconds in conformity with JPCA-BM02 standards, and any abnormality such as swelling, burnt mark and the like was not shown in the appearance.

As the chemical resistance of samples printed in 100EN, samples cut into 5 cm×5 cm were immersed in 2 mole/l hydrochloric acid aqueous solution and 2 mole/l sodium hydroxide aqueous solution at room temperature for 15 minutes, rinsed by water, and dried at 100° C. for 30 minutes, changes in mass between before and after immersion were then measured, and the result was a change in mass of 3% or less and indicated good chemical resistance.

The solvent resistance was tested with isopropanol and methyl ethyl ketone on the same conditions as in the evaluation of chemical resistance, and as a result, the change in mass was 3 percent by mass or less in isopropanol, while being 20 percent by mass or less in methyl ethyl ketone, indicating good solvent resistance.

The coated films were extracted from the above-mentioned samples, the residual solvent amount was measured by pyrolysis gas chromatography (method of heating the sample to 300° C., and trapping the generated gas to measure by gas chromatography), and the result was about 20 ppm.

The repulsion force of samples printed in 100EN was 31 g. Further, the degree of strong-elongation was measured on coated films obtained by removing copper foils by etching from samples printed in F2-WS, and the result showed the degree of elongation exceeding 20%, and indicated tough coated films.

### (Evaluations of Layered Product)

Using Espanex M (made by Nippon Steel Chemical Co., Ltd.) (thickness of the insulating layer: 25 μm, the conductor layer: Copper foil F2-WS (18 μm)) as a base of a flexible printed circuit board, prepared were comb-shaped circuit boards with line/space: 30 μm/30 μm, 50 μm/50 μm, 100 μm/100 μm, 200 μm/200 μm. The ink was printed on part of the circuit board, electrolytic nickel-gold plating was applied to the part without printing with the nickel thickness of about 5 μm and gold thickness of about 0.5 μm, and it was confirmed that crawling of plating in the part with the ink printed therein was less than 100 μm by micro X-ray florescence analysis. Further, as a result of observing the cross section, crawling of plating in the part with the ink printed therein was less than 10 μm, and it was confirmed that the insulation state between traces was excellent by a resistor. Moreover, the ink was printed in a comb-shaped area of the comb-shaped circuit board, and reliability tests were performed such that the resistance was measured while letting the boards stand for 1000 hours under conditions of DC 50V, 85° C. and humidity 85%. The resistance exceeding 10⁹Ω was maintained in all the boards during the test, and excellent results were obtained.

Further, using two-layer copper laminated sheets of Espanex M (made by Nippon Steel Chemical Co., Ltd.) (thickness of the insulating layer: 25 m, the conductor layer: Copper foil F2-WS (18 μm)), carbon dioxide gas laser vias with the diameter of 100 μm were generated, copper plating was applied, and two-layer component mounting circuit boards were prepared. The ink was printed on the circuit board except component mounting areas, components were fixed to unprinted areas by soldering paste, and mounted with an IR reflow furnace at 260° C., and any abnormalities were shown in the ink surface and wiring areas. Further, the component non-mounting areas were bent to 180 degrees and incorporated in an electronic device, and the device operated excellently under conditions of 85° C., humidity 85% and DC 50V for more than 1000 hours.

### EXAMPLE 2

### (Synthesis of Organosilicon-Group-Containing Polyimide Solution)

An organosilicon-group-containing polyimide solution was synthesized in the same method as in Example 1 except 27.92 (90 mM) of ODPA, 65.78 g (225 mM) of APB, and 13.15 g (45 mM) of TPE-R put in the second stage.

### (Preparation of the Composition)

A composition was prepared in the same method as in Example 1.

### (Evaluations of Printing•Continuous Printing)

Evaluations were made in the same method as in Example 1, and excellent results were obtained.

### (Evaluations of the Coated Film After Coating and Drying)

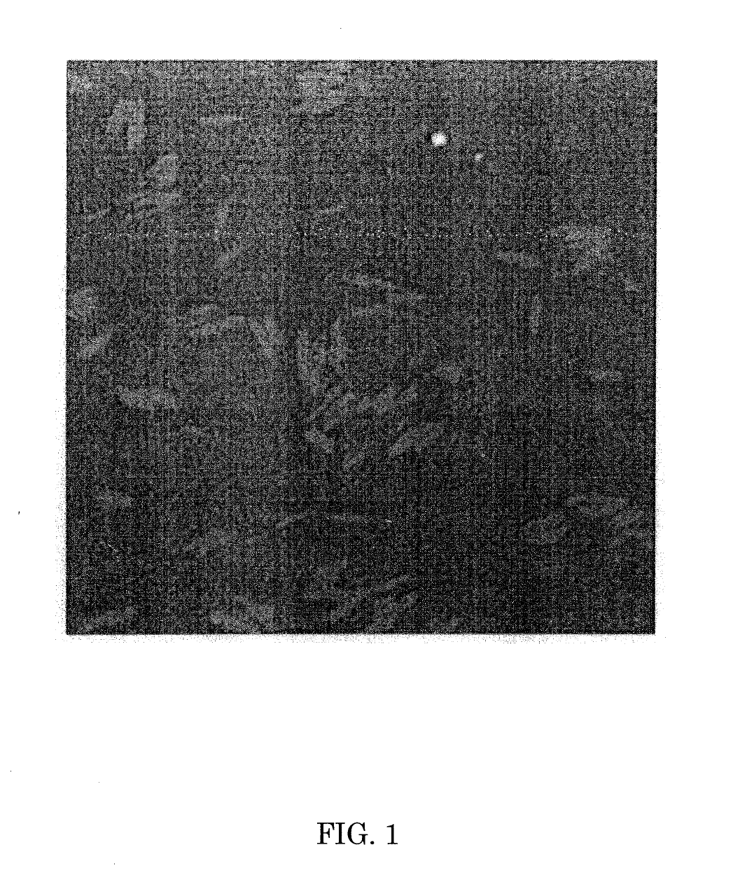

Evaluations were made in the same method as in Example 1, and excellent results were obtained. FIG. 1 shows a photograph of the cross section of the obtained coated film. Magnesium hydroxide was dispersed favorably. The obtained coated film was subjected to the acid resistance test by immersing the film in 30 percent by mass of sulfuric acid aqueous solution at room temperature for 24 hours, the immersion solution was then analyzed, and the result showed that heavy metal did not elute.

### (Electric Characteristics)

Migration tests (85° C., humidity 85%, DC 50V) were performed on comb-shaped circuit broads with line/space: 50 μm/50 μm, 100 μm/100 μm prepared in (Evaluations of printing•continuous printing) for 1000 hours, and the result showed excellent insulation reliability of 10¹⁰Ω or more.

### EXAMPLE 3

### (Synthesis of Organosilicon-Group-Containing Polyimide Solution)

An organosilicon-group-containing polyimide solution was synthesized in the same method as in Example 2.

### (Preparation of the Composition)

A composition was prepared in the same method as in Example 2 except the additive amount of aluminum acetylacetonate being 0 g.

### (Evaluations of the Coated Film After Coating and Drying)

The solvent resistance was evaluated in the same method as in Example 1, and as a result, a change in mass was 20 percent by mass with respect to methyl ethyl ketone in the immersion test at room temperature for 2 minutes.

### EXAMPLE 4

### (Synthesis of Organosilicon-Group-Containing Polyimide Solution)

An organosilicon-group-containing polyimide solution was synthesized in the same method as in Example 1 except ethyl benzoate substituted for n-butyl benzoate.

### (Preparation of the Composition)

A composition was prepared in the same method as in Example 1 except ethyl benzoate substituted for n-butyl benzoate.

### (Evaluations of Printing•Continuous Printing)

Continuous printing was evaluated in the same method as in Example 1, and as a result, any abnormality was not shown in printing results up to a lapse of an hour. The same excellent results were obtained in the other items.

### (Evaluations of the Layered Product)

Using Espanex M (made by Nippon Steel Chemical Co., Ltd.) (thickness of the insulating layer: 25 μm, the conductor layer: Copper foil F2-WS (18 μm)) as a base of a flexible printed circuit board, prepared were comb-shaped circuit boards with line/space: 30 μm/30 μm, 50 μm/50 μm, 100 μm/100 μm, 200 μm/200 μm. Coverlay CISV 1215 (made by Nikkan Industries Co., Ltd.) formed of thermosetting resin was applied onto a comb-shaped area of the comb-shaped circuit board, and reliability tests were performed such that the resistance was measured while letting the boards stand for 1000 hours under conditions of DC 50V, 85° C. and humidity 85%. The case that a value of resistance does not reach 10⁹Ω occurred frequently, and the reliability was poor.

Further, the repulsion force was measured on a layered product and 64 g/cm. The layered product was prepared by applying Coverlay CISV 1215 (made by Nikkan Industries Co., Ltd.) onto a base obtained by removing the conductor layer of Espanex M (made by Nippon Steel Chemical Co., Ltd.) (thickness of the insulating layer: 25 μm, the conductor layer: Copper foil F2-WS (18 μm)) by etching, and thus poor in bending incorporation characteristics.

### EXAMPLE 5

### (Synthesis of Organosilicon-Group-Containing Polyimide Solution)

An organosilicon-group-containing polyimide solution was synthesized in the same method as in Example 1 except methyl benzoate substituted for n-butyl benzoate.

### (Preparation of the Composition)

A composition was prepared in the same method as in Example 1 except methyl benzoate substituted for n-butyl benzoate.

### (Evaluations of Printing•Continuous Printing)

Continuous printing was evaluated in the same method as in Example 1, and as a result, the same excellent results were obtained except any abnormality being not shown in printing results after a lapse of an hour.

### EXAMPLE 6

### (Synthesis of Organosilicon-Group-Containing Polyimide Solution)

An organosilicon-group-containing polyimide solution was synthesized in the same method as in Example 1 except N-methyl-2-pyrrolidone substituted for γ-butyrolactone.

### (Preparation of the Composition)

A composition was prepared in the same method as in Example 1.

### (Evaluations of Printing•Continuous Printing)

Evaluations were made in the same method as in Example 1, and as a result, the same excellent results were obtained.

### EXAMPLE 7

### (Synthesis of Organosilicon-Group-Containing Polyimide Solution)

An organosilicon-group-containing polyimide solution was synthesized in the same method as in Example 1 except N,N-dimethylacetamide substituted for γ-butyrolactone.

### (Preparation of the Composition)

A composition was prepared in the same method as in Example 1.

### (Evaluations of Printing•Continuous Printing)

Continuous printing was evaluated in the same method as in Example 1, and as a result, the same excellent results were obtained except any abnormality being not shown in printing results after a lapse of 1.5 hour.

### EXAMPLE 8

### (Synthesis of Organosilicon-Group-Containing Polyimide Solution)

An organosilicon-group-containing polyimide solution was synthesized in the same method as in Example 1 except N,N-dimethylformamide substituted for γ-butyrolactone.

### (Preparation of the Composition)

A composition was prepared in the same method as in Example 1.

### (Evaluations of Printing•Continuous Printing)

Continuous printing was evaluated in the same method as in Example 1, and as a result, the same excellent results were obtained except any abnormality being not shown in printing results after a lapse of 1.5 hour.

### EXAMPLE 9

### (Synthesis of Organosilicon-Group-Containing Polyimide Solution)

An organosilicon-group-containing polyimide solution was synthesized in the same method as in Example 1 except dimethylsulfoxide substituted for γ-butyrolactone.

### (Preparation of the Composition)

A composition was prepared in the same method as in Example 1.

### (Evaluations of Printing•Continuous Printing)

Continuous printing was evaluated in the same method as in Example 1, and as a result, the same excellent results were obtained except any abnormality being not shown in printing results after a lapse of 1.5 hour.

### EXAMPLE 10

### (Synthesis of Organosilicon-Group-Containing Polyimide Solution)

An organosilicon-group-containing polyimide solution was synthesized in the same method as in Example 1 except isoamyl benzoate substituted for n-butyl benzoate.

### (Preparation of the Composition)

A composition was prepared in the same method as in Example 1 except methyl benzoate substituted for n-butyl benzoate.

### (Evaluations of Printing•Continuous Printing)

Continuous printing was evaluated in the same method as in Example 1, and as a result, the same excellent results were obtained except any abnormality being not shown in printing results after a lapse of 2 hours.

### COMPARATIVE EXAMPLE 1

### (Synthesis of Organosilicon-Group-Containing Polyimide Solution)

An organosilicon-group-containing polyimide solution was synthesized in the same method as in Example 1.

### (Preparation of the Composition)

A composition was prepared in the same method as in Example 1.

### (Evaluations of the Coated Film After Coating and Drying)

Evaluations were made in the same method as in Example 1 except drying conditions of 120° C.×60 minutes and 250° C.×60 minutes after coating the composition, and as a result, curling was 40 mm or more and thus appeared. The residual solvent amount was measured in the same method as in Example 1, and the result was about 2 ppm.

### COMPARATIVE EXAMPLE 2

### (Synthesis of Organosilicon-Group-Containing Polyimide Solution)

An organosilicon-group-containing polyimide solution was synthesized in the same method as in Example 2.

### (Preparation of the Composition)

A composition was prepared in the same method as in Example 2 except use of magnesium hydroxide (the result of composition analysis by X-ray fluorescence analysis: Mg 70 percent by mass and Zn 30 percent by mass), as the magnesium hydroxide, with the average particle size of 1.0 μm and specific surface area of 3.0 m²/g subjected to surface treatment with a silane coupling agent.

### (Evaluations of the Coated Film After Coating and Drying)

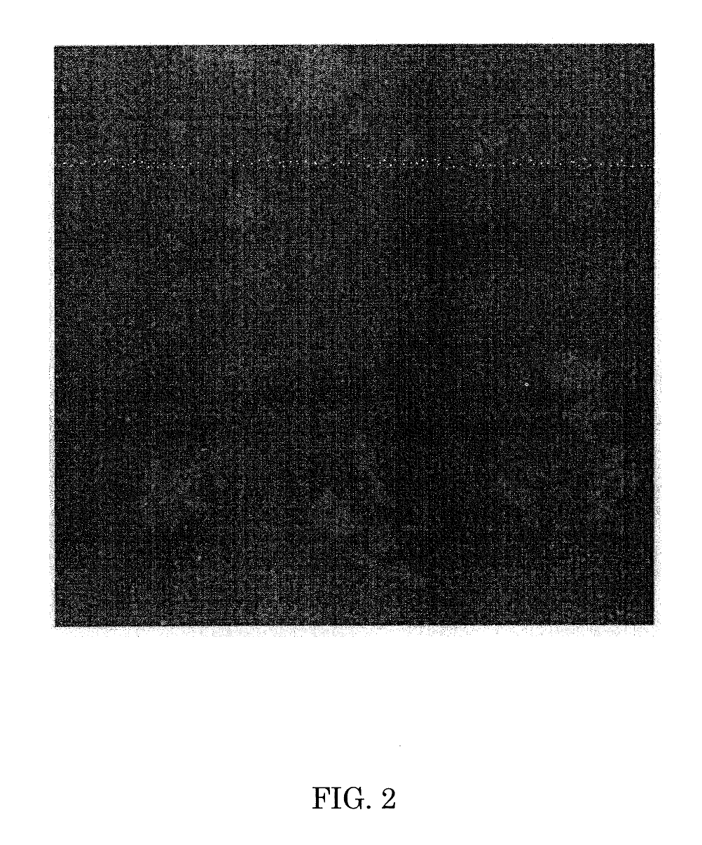

FIG. 2 shows a photograph of the cross section of a coated film obtained in the same method as in Example 2. The photograph shows coagulated magnesium hydroxide, and the dispersion property was poor. The result of the acid resistance test as in Example 2 showed elution of Zn that is heavy metal.

### COMPARATIVE EXAMPLE 3

### (Synthesis of Organosilicon-Group-Containing Polyimide Solution)

An organosilicon-group-containing polyimide solution was synthesized in the same method as in Example 1.

### (Preparation of the Composition)

A composition was prepared in the same method as in Example 1.

### (Evaluations of Printing•Continuous Printing)

Printing was performed in the same method as in Example 1, and a coated film was prepared.

### (Evaluations of the Coated Film After Coating and Drying)

Evaluations were made in the same method as in Example 1 except drying conditions of 120° C.×60 minutes after coating the composition and heat treatment being not performed. As a result, the residual solvent amount exceeded 100 ppm, the heat resistance deteriorated, and blisters were shown.

### COMPARATIVE EXAMPLE 4

### (Synthesis of Organosilicon-Group-Containing Polyimide Solution)

An organosilicon-group-containing polyimide solution was synthesized in the same method as in Example 1, substituting only methyl benzoate for n-butyl benzoate and γ-butyrolactone.

### (Preparation of the Composition)

A composition was prepared in the same method as in Example 1, substituting methyl benzoate for n-butyl benzoate. The rate of volatilization of the composition was 3.6 percent by mass/hour.

### (Evaluations of Printing•Continuous Printing)

As a result of continuous printing evaluated in the same method as in Example 1, clogging occurred in the screen during the printing, portions lacking printing appeared, and it was found out that the continuous printing property deteriorated.

### COMPARATIVE EXAMPLE 5

### (Synthesis of Organosilicon-Group-Containing Polyimide Solution)

An organosilicon-group-containing polyimide solution was synthesized in the same method as in Example 1, substituting only phenyl benzoate for n-butyl benzoate and γ-butyrolactone.

### (Preparation of the Composition)

A composition was prepared in the same method as in Example 1, substituting phenyl benzoate for n-butyl benzoate.

### (Evaluations of Printing•Continuous Printing)

Printing was performed in the same method as in Example 1, and a coated film was prepared.

### (Evaluations of the Coated Film After Coating and Drying)

A result of evaluations made in the same method as in Example 1 showed a reduction in heat resistance and deformation.

### COMPARATIVE EXAMPLE 6

### (Synthesis of Organosilicon-Group-Containing Polyimide Solution)

A bulb condenser provided with a moisture isolation trap was attached to a 2 L-separable three-neck flask provided with an anchor-type stirrer made of stainless steel. In the flask were placed 111.68 g (360 mM) of ODPA, 165.24 g (180 mM) of diamino siloxane compound BY16-853U (made by Dow Corning Toray) (amino group equivalent: 459, hereinafter abbreviated as BY16), 4.33 g (43 mM) of γ-valerolactone, 6.83 g (86 mM) of pyridine, 134.4 g of ethyl benzoate, and 120 g of triglyme. The mixture was stirred at room temperature at the stirring rate of 180 rpm in an atmosphere of nitrogen for 30 minutes, and further stirred at 180° C. for an hour. The water was removed during the reaction.

Then, the resultant was cooled to room temperature, and added were 22.34 g (72 mM) of ODPA, 63.15 g (216 mM) of 1,3-bis(3-aminophenoxy)benzene (made by Mitsui Chemicals, Inc.) (hereinafter abbreviated as APB), 10.52 g (36 mM) ₒf 1,3-bis(4-aminophenoxy)benzene (made by Wakayama Seika Kogyosha) (hereinafter abbreviated as TPE-R), 80 g of ethyl benzoate, and 120 g of triglyme. The mixture was reacted at 180° C. for 5 hours while stirring at 180 rpm. By removing reflux materials such as water out of the system during the reaction, obtained was an organosilicon-group-containing polyimide solution with the density of 41 percent by mass.

### (Preparation of the Composition)

To 900 g of synthesized organosilicon-group-containing polyimide solution were added 130 g of ethyl benzoate, 195 g of triglyme, 55.5 g (6 parts by mass with respect to 100 parts by mass of organosilicon-group-containing polyimide) of magnesium hydroxide, subjected to surface treatment by silica, with the average particle size of 0.8 μm and the specific surface area of 9.0 m²/g (from the result of composition analysis by X-ray fluorescence analysis, Mg 84.4 percent by mass, Si 14.9 percent by mass, Fe 0.04 percent by mass, Zn 0.02 percent by mass), 11.1 g of anti-foaming agent (Shin-Etsu Chemical Co., Ltd. KS-603), 3.7 g (0.4 part by mass with respect to 100 parts by mass of organosilicon-group-containing polyimide) of aluminum acetylacetonate, and 7.38 g of phthalocyanine blue powder that is an organic pigment, the mixture was adequately mixed with NR-120A Ceramic three-roll mill (made by Noritake Co., Limited), and a composition of the invention was obtained. The solubility parameter of the mixed solvent of two kinds or more contained in the composition was 8.86.

### (Evaluations of Printing•Continuous Printing)

The composition was stored for 3 months after being prepared, and printing was then performed on the same conditions as in Example 1. The printing property deteriorated due to increases in the viscosity, and thin spots appeared.

### COMPARATIVE EXAMPLE 7

### (Synthesis of Organosilicon-Group-Containing Polyimide Solution)

An organosilicon-group-containing polyimide solution was synthesized in the same method as in Example 2.

### (Preparation of the Composition)

A composition was prepared in the same method as in Example 2 except use of magnesium hydroxide with the average particle size of 7.0 μm as the magnesium hydroxide.

### (Evaluations of Printing•Continuous Printing)

Printing was performed in the same method as in Example 1, and a coated film was prepared.

### (Evaluations of the Coated Film After Coating and Drying)

Evaluations were made in the same method as in Example 1 while floating in a bath of molten solder, the result showed changes in the appearance, and blisters were shown in a result of observing with a light microscope. The blistered portion was observed with a scanning electron microscope provided with EDX equipment (energy dispersive X-ray spectroscopy), and as a result, the agglomeration of magnesium hydroxide was recognized.

### COMPARATIVE EXAMPLE 8

### (Synthesis of Organosilicon-Group-Containing Polyimide Solution)

An organosilicon-group-containing polyimide solution was synthesized in the same method as in Example 1, substituting only triglyme for n-butyl benzoate and γ-butyrolactone.

### (Preparation of the Composition)

A composition was prepared in the same method as in Example 1, substituting triglyme for n-butyl benzoate.

### (Evaluations of Printing•Continuous Printing)

A coated film was prepared in the same method as in Example 1.

### (Evaluations of the Coated Film After Coating and Drying)

As a result of measuring the degree of strong-elongation of the coated film, the degree of elongation did not reach 20%, and the coated film was thus brittle.

### INDUSTRIAL APPLICABILITY

The composition of the invention has good viscosity stability and flowability at the time of processing, good shape retention after the processing, and good drying property in a temperature range of not degrading the conductor layer at the time of drying, enables a coated film excellent in strength of adhesion with metal•polyimide, flame resistance, heat resistance, flexibility, mechanical properties, and chemical resistance to be obtained after being dried, and therefore, can be used suitably in the field of substrate material for printed circuit boards having an electronic circuit.

1. A composition containing:
(A) polyimide; and
(B) a mixed solvent of two kinds or more,
wherein a solubility parameter of the mixed solvent of two kinds or more ranges from 9 to 14, and
wherein the composition contains 100 parts by mass of the polyimide, and (D) 0.1 to 10 parts by mass of acetylacetone metal complex.

2. The composition according to claim 1, wherein the acetylacetone metal complex is a complex of light metal.

3. The composition according to claim 2, wherein the acetylacetone metal complex is aluminium complex.
